(19) United States
(12) Patent Application Publication
(10) Pub. No.: US 2014/0210579 A1
(43) Pub. Date: Jul. 31, 2014

(54) MAGNET ASSEMBLY

(71) Applicants: Thorsten Alexander Kern, Alsbach (DE); Andreas Walther, Bruchkobel (DE)

(72) Inventors: Thorsten Alexander Kern, Alsbach (DE); Andreas Walther, Bruchkobel (DE)

(21) Appl. No.: 13/997,153

(22) PCT Filed: Dec. 21, 2011
(86) PCT No.: PCT/EP2011/073543

§ 371 Date: Dec. 10, 2013

(30) Foreign Application Priority Data
Dec. 22, 2010 (DE) 102010055481.2

(51) Int. Cl. H01F 7/02

(52) U.S. Cl. CPC H01F 7/021
USPC 335/302

(57) ABSTRACT

A magnet assembly, having a disk-shaped magnet, which is made predominantly of metal material and has a through-hole and, by the through-hole, can be placed onto a region of a shaft made of plastic by a press fit. In the region of the magnet placed onto the shaft, the shaft has a diameter that is smaller than the diameter of the through-hole. The shaft has a plurality of radially protruding projections in the region of the magnet placed onto the shaft. The projections are distributed evenly on the circumference of the shaft and, with respect to the longitudinal axis of the shaft, having a radius, the double of which is oversized relative to the diameter of the through-hole before the magnet is placed onto the projections of the shaft.

### CROSS REFERENCE TO RELATED APPLICATIONS

This is a U.S. national stage of application No. PCT/EP2011/073543, filed on Dec. 21, 2011. Priority is claimed on German Application No. DE102010055481.2 filed Dec. 22, 2010; the content of which is incorporated here by reference.

### BACKGROUND OF THE INVENTION

1. Field of the Invention

The invention relates to a magnet assembly with a disk-shaped magnet of predominantly metallic material, which has a through-hole by which through-hole the magnet assembly can be placed on a region of a shaft plastic by a press fit.

2. Description of Prior Art

Due to the brittle nature of the magnet material, when the magnet is pressed onto the shaft, the magnet can split open.

This risk also persists over the life of the magnet assembly due to ageing and embrittlement of the magnet material.

The magnet can also split open due to a temperature rise due to the substantially higher expansion coefficient of the shaft material in comparison with the magnet material.

Furthermore the holding force of the magnet on the shaft can be reduced by a creeping of the plastic material of the shaft, in particular over the life of the magnet assembly.

### SUMMARY OF THE INVENTION

An object of one embodiment of the invention is a magnet assembly of the type cited initially that can be produced economically and allows a permanently firm arrangement of the magnet on the shaft with no risk of the magnet splitting open.

According to one embodiment of the invention, in the region of the applied magnet, the shaft has a diameter that is smaller than the diameter of the through-hole, and that in the region of the applied magnet, the shaft is formed with a multiplicity of radially projecting protrusions arranged evenly distributed on the circumference of the shaft and with respect to the longitudinal axis of the shaft have a radius, the double of the radius of the protrusions is oversized in relation to the diameter of the through-hole before application of the magnet on the protrusions of the shaft.

Since there is no need for tight tolerance, but only for rough tolerance of the diameter of the through-hole of the magnet and of the radius in the region of the protrusions, the magnet assembly can be produced economically.

The cavities between the radially projecting protrusions, into which the excess material of the protrusions can creep both on assembly of the magnet and over the life of the magnet assembly, ensure a permanently firm seat of the magnet on the shaft without the magnet splitting open due to a temperature rise.

In relation to the fit by which the magnet sits on the shaft, the spacing between the contact surface of the protrusions and the contact surface of the through-hole that exists before the joining of the two parts is oversized when the actual radial dimension of the shaft at the protrusions is greater than that of the through-hole.

Ease of production by simple removal of the shaft from the mold is achieved if the protrusions are webs that extend parallel to the longitudinal axis of the shaft.

If the webs extend axially out of the through-hole of the magnet on one or both sides, the plastic material of the webs creeps axially out of the opening(s) of the through-hole, radially towards the outside by a specific amount.

Thus axial stops are produced which axially secure the magnet against slipping on the shaft by a form-fit connection.

A particularly concentric arrangement of the magnet on the shaft is achieved if the shaft is formed with an odd number of webs, wherein the shaft can be formed with three webs which extend between 20° and 60°, in particular by 40°, in the circumferential direction.

This extension of the webs in the circumferential direction ensures a volume between the webs sufficient to receive the creeping material of the shaft.

For easy assembly into the nominal position of the magnet on the shaft, the shaft can have a radially protruding stop shoulder at one axial end of the region formed with the protrusions, and the magnet can be placed on the shaft until it rests on the stop shoulder.

If at the end opposite the stop shoulder, the webs run out in the manner of a ramp to the cylindrical casing surface of the shaft, no stops are formed at this end which could hinder the application of the magnet and where applicable lead to chipping of the webs, since by its through-hole the magnet slides over the ramps onto the webs.

The shaft can be formed as a worm screw shaft in a region spaced axially from the region of the protrusions.

Because of the fixed arrangement of the magnet on the shaft, the torques transmitted by the worm screw shaft do not lead to a relative twist of the magnet on the shaft.

### BRIEF DESCRIPTION OF THE DRAWINGS

One exemplary embodiment of the invention is shown in the drawing and described in more detail below. In the drawings:

FIG. 1 is a side view of a magnet assembly;

FIG. 2 is an enlarged extract “X” from the magnet assembly in FIG. 1;

FIG. 3 is a perspective view of a shaft of the magnet assembly in FIG. 1;

FIG. 4 is a side view of the shaft of the magnet assembly in FIG. 1; and

FIG. 5 is a front view of the shaft of the magnet assembly in FIG. 1.

### DETAILED DESCRIPTION OF THE PREFERRED EMBODIMENTS

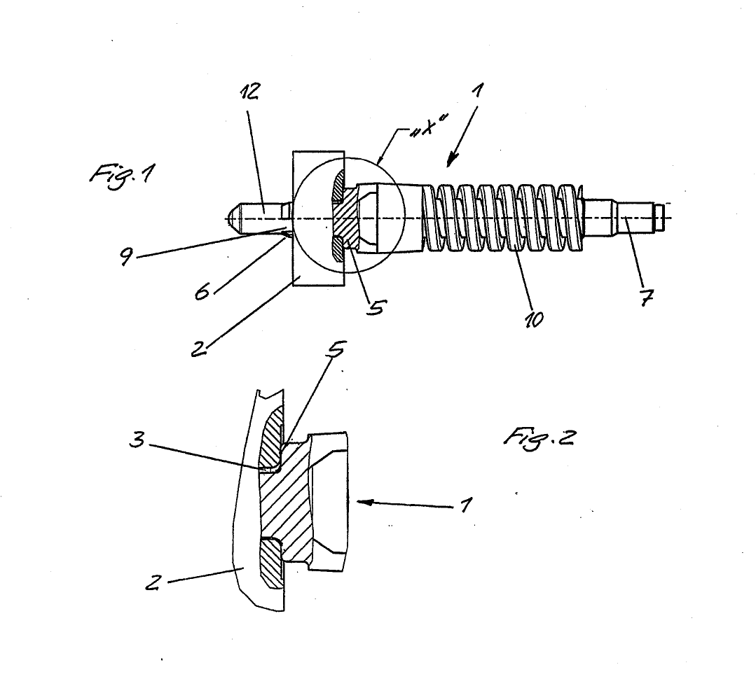

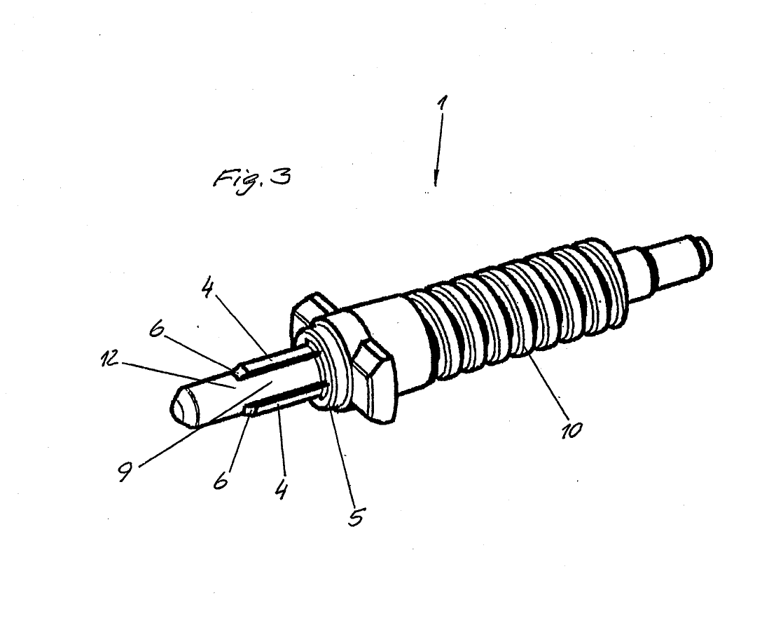

The magnet assembly shown in FIG. 1 has a shaft 1 of plastic on which, in an end region 12 of the shaft 1, a magnet 2 is placed by a press fit, which magnet 2 is formed as a permanent magnet and has a through-hole 3 and consists predominantly of a metallic material.

The shaft 1 in the end region 12 has a diameter which is smaller than the diameter of the through-hole 3 of the magnet 2.

In the region of the shaft 1 in which the disk-shaped magnet is applied, the shaft 1 is formed with three radially projecting webs 4 (FIGS. 3-5) which extend parallel to the longitudinal axis 7 of the shaft and are evenly distributed over the circumference of the shaft 1 and extend up to a radially protruding stop shoulder 5 of the shaft 1.

The length of the webs 4 is greater than the axial length of the magnet 2 so that they protrude out of the through-hole 3.

At their end 6 opposite the stop shoulder 5, the webs 4 run out in the manner of a ramp to the cylindrical casing surface of the end region 12 of the shaft 1.

Each of the webs 4 extends through an angle 11 of 40° in the circumferential direction (FIG. 5).

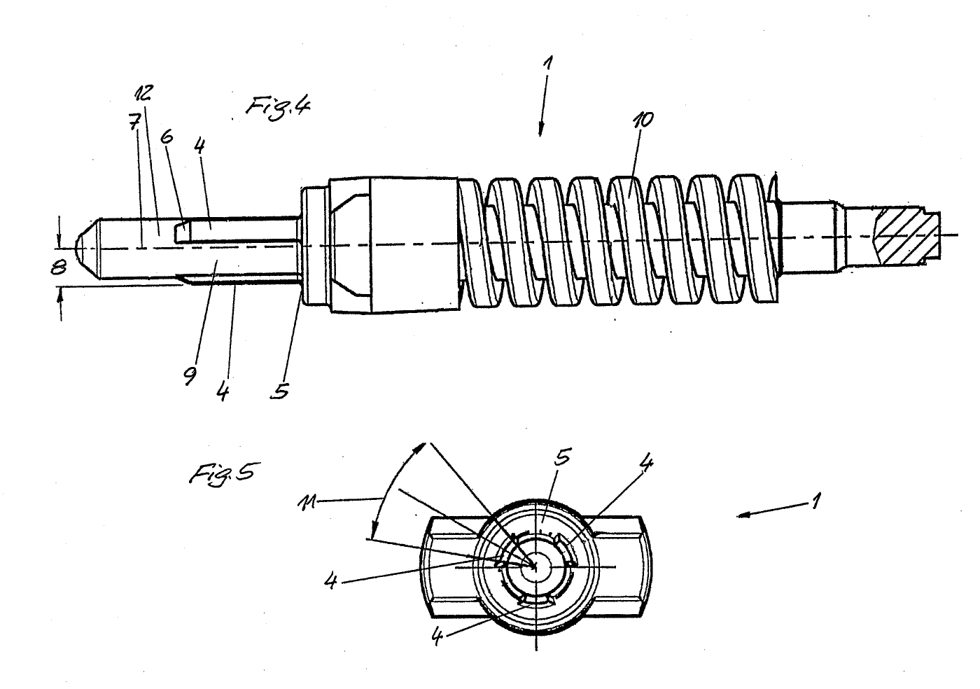

Before the magnet 2 is placed on the shaft 1, in relation to the longitudinal axis 7 of the shaft, twice the radius 8 of the webs 4 is oversized in relation to the diameter of the through-hole 3 (FIG. 4).

As an example of the order of magnitude, the oversize for a diameter of the through-hole 3 of 1.35±0.015 mm can be greater than 8/100 mm.

If by its through-hole 3 the magnet 2 is pushed onto the webs 4 until it rests on the stop shoulder 5, the excess material of the webs 4 creeps into the cavities 9 between the webs 4 so that the magnet 2 sits firmly on the shaft 1 in the region of the webs 4 but is not exposed to any radial stress which could lead to bursting of the magnet 2 (FIG. 4).

At the ends 6 of the webs 4 protruding from the through-hole 3, the webs 4 have a radial curvature whereby the magnet 2 is axially secured in its fitting position.

On the side of the stop shoulder 5 facing away from the webs 4, the shaft 1 is formed as a worm screw shaft 10.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-9. (canceled)

10. A magnet assembly comprising:
a shaft having a longitudinal axis; and
a disk-shaped magnet of a metallic material having a through-hole by which the disk-shaped magnet can be placed on the shaft by a press fit in an applied region,
wherein in the applied region, the shaft has a diameter smaller than a diameter of the through-hole, and
wherein in the applied region, the shaft has a plurality of radially projecting protrusions that are arranged evenly distributed on a circumference of the shaft with respect to the longitudinal axis of the shaft, each protrusion having a radius, twice the radius of each protrusion being oversized with respect to a diameter of the through-hole before application of the disk-shaped magnet on the plurality of radially projecting protrusions of the shaft.

11. The magnet assembly as claimed in claim 10, wherein each radially projecting protrusion is a web that extends parallel to the longitudinal axis of the shaft.

12. The magnet assembly as claimed in claim 11, wherein the webs extend axially out of the through-hole of the disk-shaped magnet at least one side.

13. The magnet assembly as claimed in claim 11, wherein the shaft has an odd number of webs.

14. The magnet assembly as claimed in claim 13, wherein the shaft has three webs that extend between 20° and 60° in a circumferential direction of the shaft.

15. The magnet assembly as claimed in claim 13, wherein the webs extend over 40° in a circumferential direction of the shaft.

16. The magnet assembly as claimed in claim 11, wherein the shaft has a radially protruding stop shoulder at one axial end of the applied region formed with the plurality of radially projecting protrusions, and the disk-shaped magnet is configured to be pressed onto the shaft until it rests on the radially protruding stop shoulder.

17. The magnet assembly as claimed in claim 16, wherein at their respective ends opposite the radially protruding stop shoulder, the webs run out in a ramp to a cylindrical surface of the shaft.

18. The magnet assembly as claimed in claim 10, wherein the shaft is formed as a worm screw shaft in a region axially spaced from the region of the plurality of radially projecting protrusions.

19. The magnet assembly as claimed in claim 12, wherein the shaft is formed with an odd number of webs.
